(19) United States
(12) Patent Application Publication
(10) Pub. No.: US 2025/0276333 A1
(43) Pub. Date: Sep. 4, 2025

(54) TOP SHOWER

(71) Applicant: Xiamen Aokecheng Technology Co., Ltd, Xiamen (CN)

(72) Inventor: Shengwu ZHANG, Xiamen (CN)

(73) Assignee: Xiamen Aokecheng Technology Co., Ltd, Xiamen (CN)

(21) Appl. No.: 18/592,814

(22) Filed: Mar. 1, 2024

(51) Int. Cl. B05B 1/18; B05B 1/16

(52) U.S. Cl. CPC B05B 1/18; B05B 1/1681

(57) ABSTRACT

A top shower includes a base, a water diversion plate, a water diversion disk, a water inlet connector, and an adjustment component. The water inlet connector is connected to a top surface of the base. A variety of types of water outlets are provided on a bottom surface of the base. The water diversion plate is fixedly arranged in the base, and is provided with a plurality of flow diversion ports at intervals in a circumferential direction of the water diversion disk. The flow diversion ports are communicated with the water outlets respectively. The water diversion disk is rotatably arranged in the base, and is matched with the water diversion plate. A water diversion port is provided on the water diversion disk. In this disclosure, different water discharge manners can be selected based on a requirement, the water discharge manners can be switched conveniently through a simple structure.

### TECHNICAL FIELD

The disclosure relates to the field of bathroom products, and in particular, to a top shower.

### BACKGROUND

A top shower is a shower fixed overhead. A user does not need to hold the shower in a bath, so that the hands can be freed for the bath more comfortably.

In the related art, the top shower includes a base and a water inlet connector. A water outlet is provided on a bottom surface of the base. The water inlet connector is connected to a water supply pipeline. In this way, water flows in from the water inlet connector, and is sprayed out from a water outlet. Therefore, water discharge of the top shower is implemented for the bath of the user.

However, during actual application, most top showers have only one water discharge manner, are unlikely to meet requirements of different people and not so applicable, and thus need to be improved.

### SUMMARY

To meet requirements of different people, the disclosure provides a top shower. Different water discharge manners can be selected based on a requirement, and the water discharge manners can be switched conveniently through a simple structure.

The following technical solution is used for the top shower provided in the disclosure.

The top shower includes a base, a water diversion plate, a water diversion disk, a water inlet connector, and an adjustment component. The water inlet connector is connected to a top surface of the base. A variety of types of water outlets are provided on a bottom surface of the base. The water diversion plate is fixedly arranged in the base, and is provided with a plurality of flow diversion ports at intervals in a circumferential direction of the water diversion disk. The flow diversion ports are communicated with the water outlets respectively. The water diversion disk is rotatably arranged in the base, and is matched with the water diversion plate. A water diversion port is provided on the water diversion disk. When the water diversion disk is rotated, the water diversion port is selectively communicated with the plurality of flow diversion ports. The adjustment component includes a pulling button movably arranged on a side of the base and a pulling rod connected to the water diversion disk and the pulling button respectively. The pulling button drives, through the pulling rod, the water diversion disk to rotate.

In a preferred embodiment, the base includes a water outlet panel. The water outlet is provided on the water outlet panel. Water outlet channels correspondingly communicating the water diversion ports with the water outlets are formed between a bottom surface of the water diversion plate and a top surface of the water outlet panel. The water diversion port is provided on a top surface of the water diversion plate. A clamping ring groove is provided around the water diversion port on the top surface of the water diversion plate. The water diversion disk is provided with a plurality of elastic buckles at intervals in the circumferential direction of the water diversion disk. The plurality of elastic buckles are clamped into the clamping ring groove in an axial direction of the water diversion disk after elastically deformed. The elastic buckle is movable in a circumferential direction of the clamping ring groove.

In a preferred embodiment, a connection seat is arranged on a periphery of the water diversion disk. An end of the pulling rod away from the pulling button extends into the base, and is connected to the connection seat in a clamping manner.

In a preferred embodiment, the pulling rod is a pulling piece of a long-strip flaky structure, and is elastic. The pulling piece implements a clamping connection to the connection seat through elastic deformation.

In a preferred embodiment, a guide portion and a clamping block are arranged on the connection seat. A clamping groove is provided at an end of the pulling piece away from the pulling button. The pulling piece is inserted into the base along the guide portion, to clamp the clamping block into the clamping groove.

In a preferred embodiment, the guide portion of the connection seat extends in a radial direction of the water diversion disk. A slot is formed between the guide portion and a top surface of the water diversion plate. The clamping block is located in the slot. An avoiding groove communicated with the slot is provided at a position of the guide portion corresponding to the clamping block. The avoiding groove avoids elastic deformation of the pulling piece to enable the pulling piece to go over the clamping block. The pulling piece is inserted into the slot, and is clamped with the clamping block after elastically deformed at the avoiding groove.

In a preferred embodiment, an end of the guide portion away from the water diversion disk is upturned to a top direction of the base to gradually enlarge a size of the slot corresponding to an upturned part externally to the radial direction of the water diversion disk. A sinking groove is formed at a position that is on the top surface of the water diversion plate and that corresponds to the clamping block. The clamping block is partially located in the sinking groove.

In a preferred embodiment, the top shower further includes a flow passage seat arranged in the base and fixedly connected to the water diversion disk. The water inlet connector includes a spherical portion. The spherical portion is rotatably arranged in the flow passage eat, and is in sealing communication with the water diversion port of the water diversion disk through the flow passage seat. The base includes a water outlet panel. The water outlet is provided on the water outlet panel. Water outlet channels correspondingly communicating the flow diversion ports with the water outlets are formed between a bottom surface of the water diversion plate and a top surface of the water outlet panel. The water diversion port is provided on a top surface of the water diversion plate. A protruding rotating shaft is arranged on the top surface of the water diversion plate. The water diversion disk is provided with a first central hole. The flow passage seat is provided with a second central hole. The rotating shaft is arranged in the first central hole and the second central hole in a penetration manner. A screw hole that axially extends is provided in the rotating shaft. A screw is capable of penetrating through the water inlet connector to be matched with the screw hole to fixedly connect the flow passage seat, the water diversion disk, and the water diversion plate.

In a preferred embodiment, there are two groups of flow diversion ports that are opposite to each other. Each group of flow diversion ports include a first flow diversion port, a second flow diversion port, and a third flow diversion port that are arranged side by side. There are correspondingly two water diversion ports. The water outlets include a first water outlet, a second water outlet, and a third water outlet. A first flow passage water channel communicating the first flow diversion port with the first water outlet, a second flow passage water channel communicating the second flow diversion port with the second water outlet, and a third flow passage water channel communicating the third flow diversion port with the third water outlet are provided in the water diversion plate. There is one first flow passage water channel communicated with the two first diversion ports. There are two second flow passage water channels and two third flow passage water channels that are communicated with the two second flow diversion ports and the two third flow diversion ports in one-to-one correspondence respectively. The two second flow passage water channels and the two third flow passage water channels enclose a quadrangle. The two second flow passage water channels are arranged diagonally. The two third flow passage water channels are arranged diagonally. The first flow passage water channel is annular, and is arranged in middle in the quadrangle.

In a preferred embodiment, a water diversion cavity is provided in the water diversion disk. A top wall of the water diversion cavity forms an opening. A side wall of the water diversion cavity is communicated with that of the water diversion port. Projections of the opening and the water diversion port in an axial direction of the water diversion disk partially overlap. A sealing gasket is arranged in the water diversion port. The sealing gasket is provided with a water hole.

In summary, the disclosure has the at least one of the following beneficial technical effects.
Firstly, the water diversion disk is rotated, so that the water diversion port of the water diversion disk may be selectively communicated with the plurality of flow diversion ports, and water is sprayed out from different water outlets. A switching structure is simple. Different people can select different water discharge manners based on own requirements. Therefore, the top shower meets requirements of different people, and is more extensive in application. In addition, the pulling button and the pulling rod are used to drive the water diversion disk to rotate, so that a transmission structure is simple, and convenience is brought to a switching operation.
Secondly, the clamping ring groove is provided around the water diversion port on the top surface of the water diversion plate. The water diversion disk is provided with the plurality of elastic buckles at intervals in the circumferential direction of the water diversion disk. The plurality of elastic buckles are clamped into the clamping ring groove in the axial direction of the water diversion disk after elastically deformed. The elastic buckle is movable in the circumferential direction of the clamping ring groove. The structure is simple, and convenience is brought to assembling of connecting the water diversion disk to the water diversion plate.
Thirdly, the connection seat is arranged on the periphery of the water diversion disk. The end of the pulling rod away from the pulling button extends into the base, and is connected to the connection seat in the clamping manner. In this way, linkage between the pulling button, the pulling rod, and the water diversion disk is implemented. Therefore, the structure is simple, and convenience is brought to mounting.
Fourthly, the pulling rod is designed as the pulling piece of the long-strip flaky structure, and is elastic. The pulling piece implements the clamping connection to the connection seat through elastic deformation. A connection manner is simple and reliable.
Fifthly, the guide portion and the clamping block are arranged on the connection seat. The clamping groove is provided at the end of the pulling piece away from the pulling button. The pulling piece is inserted into the base along the guide portion, to clamp the clamping block into the clamping groove. The guide portion enables the clamping block to be smoothly aligned and clamped with the clamping groove. A clamping structure is simple.
Sixthly, the avoiding groove communicated with the slot is provided at the position of the guide portion corresponding to the clamping block. The avoiding groove avoids elastic deformation of the pulling piece to enable the pulling piece to go over the clamping block. The pulling piece is inserted into the slot, and is clamped with the clamping block after elastically deformed at the avoiding groove. A clamping structure is simple and reliable.
Seventhly, the end of the guide portion away from the water diversion disk is upturned to the top direction of the base to gradually enlarge the size of the slot corresponding to the upturned part externally to the radial direction of the water diversion disk. In this way, the pulling piece can be inserted into the slot along the upturned part of the guide portion. Higher reliability and more convenience are ensured in an insertion process.
Eighthly, the screw penetrates through the water inlet connector to be matched with the screw hole to fixedly connect the flow passage seat, the water diversion disk, and the water diversion plate. Therefore, the structure is simple, and convenience is brought to assembling.
Ninthly, the two second flow passage water channels and the two third flow passage water channels enclose the quadrangle. The two second flow passage water channels are arranged diagonally. The two third flow passage water channels are arranged diagonally. The first flow passage water channel is annular, and is arranged in middle in the quadrangle. Such design can make the water channels arranged more compact. When the water diversion plate is sealed through welding, welding lines may be formed between the flow passage water channels, so that higher welding strength and higher resistance to water pressure are ensured.
Lastly, the side wall of the water diversion cavity is communicated with that of the water diversion port. The projections of the opening and the water diversion port in the axial direction of the water diversion disk partially overlap. Such design can make it easier to implement injection molding, the water diversion cavity and the water diversion port can be communicated with each other after molded through two die cores respectively, and no additional side core-pulling for forming a side communication port to communicate the water diversion cavity with the water diversion port is required.

### BRIEF DESCRIPTION OF THE DRAWINGS

FIG. 1 is a schematic diagram of an overall assembly structure of a top shower according to an embodiment of the disclosure.

FIG. 2 is a first schematic exploded view of a top shower according to an embodiment of the disclosure.

FIG. 3 is a second schematic exploded view of a top shower according to an embodiment of the disclosure.

FIG. 4 is a bottom view of a top shower according to an embodiment of the disclosure.

FIG. 5 is a front view of a top shower according to an embodiment of the disclosure.

FIG. 6 is a sectional view in an A-A direction in FIG. 5.

FIG. 7 is an enlarged view of Part B in FIG. 6.

FIG. 8 is an enlarged view of Part C in FIG. 6.

FIG. 9 is a first schematic perspective view of a water diversion disk according to an embodiment of the disclosure.

FIG. 10 is a second schematic perspective view of a water diversion disk according to an embodiment of the disclosure.

FIG. 11 is a third schematic perspective view of a water diversion disk according to an embodiment of the disclosure.

FIG. 12 is a schematic partial view of a water diversion plate according to an embodiment of the disclosure.

### DETAILED DESCRIPTION OF THE EMBODIMENTS

Unless otherwise defined, all technical and scientific terms used in this specification have same meanings as commonly understood by a person skilled in the art that the disclosure belongs to. The terms used in this specification are merely for a purpose of describing a specific embodiment and not intended to limit the disclosure. The terms “include” and “have” and any variants thereof in the specification and claims of the disclosure and the descriptions of the accompanying drawings are intended to cover nonexclusive inclusions.

“Embodiment” mentioned in this specification means that a specific feature, structure, or characteristic described with reference to this embodiment may be included in at least one embodiment of the disclosure. The phrase shown in various locations in this specification may not necessarily refer to a same embodiment, and is not an independent or optional embodiment exclusive from another embodiment. It is explicitly and implicitly understood by a person skilled in the art that embodiments described in this specification may be combined with another embodiment.

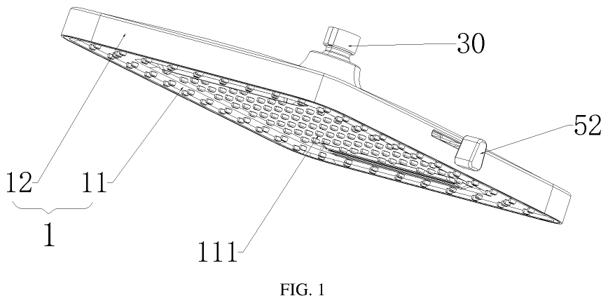

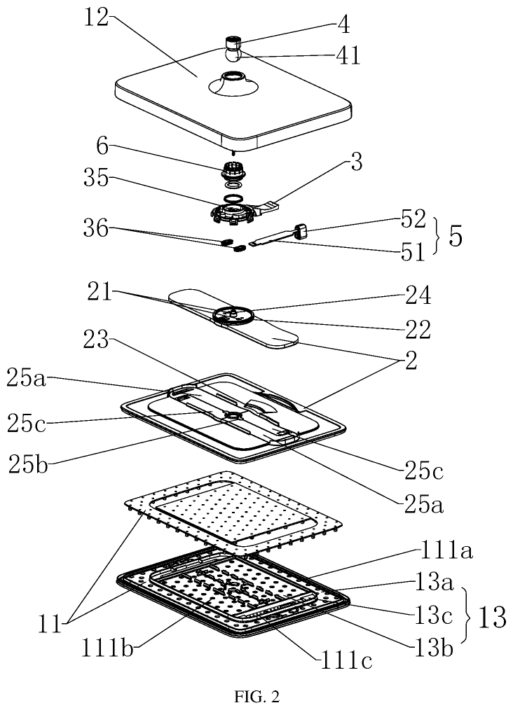

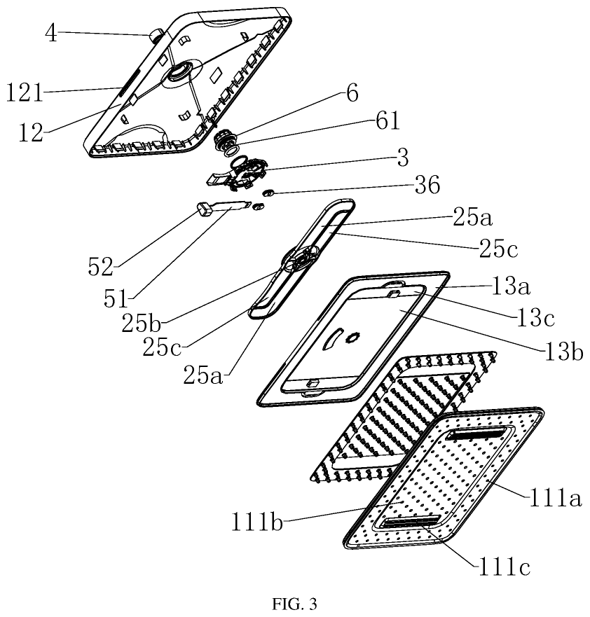

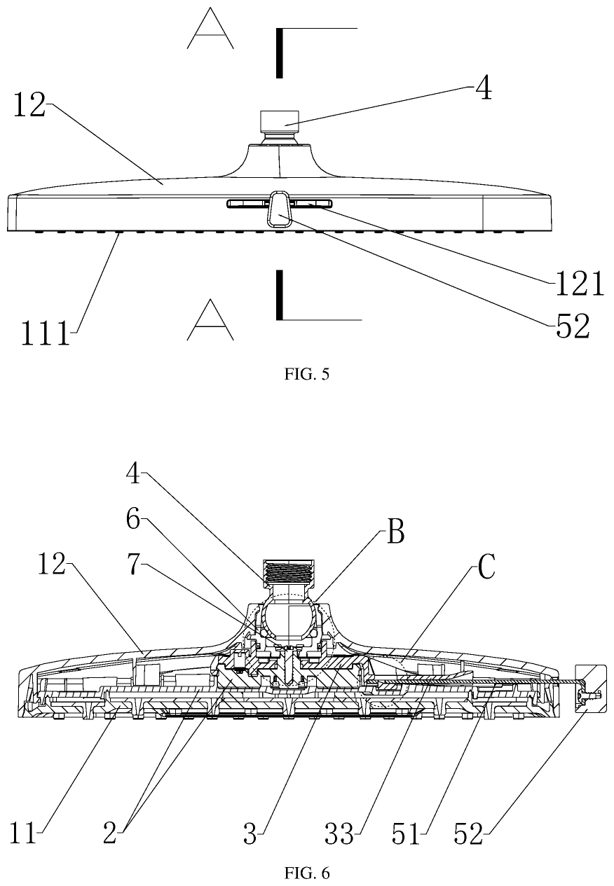

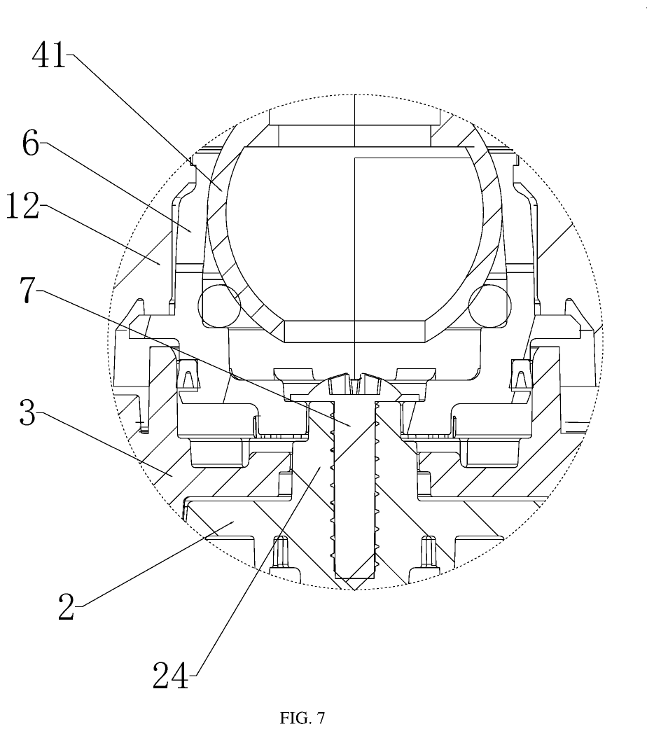

The following further describes the disclosure in detail with reference to FIG. 1 to FIG. 12.

A preferred embodiment of the disclosure discloses a top shower, including a base 1, a water diversion plate 2, a water diversion disk 3, a water inlet connector 4, and an adjustment component 5. The water inlet connector 4 is connected to a top surface of the base 1. An inlet of the water inlet connector 4 is communicated with a water supply source. A variety of types of water outlets 111 are provided on a bottom surface of the base 1. The water diversion plate 2 is fixedly arranged in the base 1, and is provided with a plurality of flow diversion ports 21 at intervals in a circumferential direction of the water diversion disk 3. The flow diversion ports 21 are communicated with the water outlets 111 respectively. The water diversion disk 3 is rotatably arranged in the base 1, and is matched with the water diversion plate 2. A water diversion port 31 is provided on the water diversion disk 3. When the water diversion disk 3 is rotated, the water diversion port 31 is selectively communicated with the plurality of flow diversion ports 21, and a water flow entering from the water inlet connector 4 sequentially passes through the water diversion port 31, the flow diversion port 21, and the water outlet 111, and is finally sprayed out from the water outlet 111. The adjustment component 5 includes a pulling button 52 movably arranged on a side of the base 1 and a pulling rod 51 connected to the water diversion disk 3 and the pulling button 52 respectively. The pulling button 52 drives, through the pulling rod 51, the water diversion disk 3 to rotate.

The water diversion disk 3 is rotated, so that the water diversion port 31 of the water diversion disk 3 may be selectively communicated with the plurality of flow diversion ports 21, and water is sprayed out from different water outlets 111. A switching structure is simple. Different people can select different water discharge manners based on own requirements. Therefore, the top shower meets requirements of different people, and is more extensive in application. In addition, the pulling button 52 and the pulling rod 51 are used to drive the water diversion disk 3 to rotate, so that a transmission structure is simple, and convenience is brought to a switching operation.

In this embodiment, the base 1 includes a water outlet panel 11 and a housing 12. The water outlet panel 11 is connected to a bottom end of the housing 12, and encloses, with the housing 12, an inner cavity. A top surface of the housing 12 is provided with an opening through which the water inlet connector penetrates. A side wall of the housing 12 is provided with a strip-type hole 121 through which the pulling rod 51 penetrates.

The water outlet 111 is provided on the water outlet panel 11. Water outlet channels 13 correspondingly communicating the flow diversion ports 21 with the water outlets 111 are formed between a bottom surface of the water diversion plate 2 and a top surface of the water outlet panel 11 respectively. The flow diversion port 21 is provided on a top surface of the water diversion plate 2. A clamping ring groove 22 is provided around the water diversion port 21 on the top surface of the water diversion plate 2. The water diversion disk 3 is provided with a plurality of elastic buckles 32 at intervals in the circumferential direction of the water diversion disk 3. The plurality of elastic buckles 32 are clamped into the clamping ring groove 22 in an axial direction of the water diversion disk 3 after elastically deformed. The elastic buckle 32 is movable in a circumferential direction of the clamping ring groove 22. Such design is simple in structure, and brings convenience to assembling of connecting the water diversion disk 3 to the water diversion plate 2.

In this embodiment, a connection seat 33 is arranged on a periphery of the water diversion disk 3. An end of the pulling rod 51 away from the pulling button 52 extends into the base 1, and is connected to the connection seat 33 in a clamping manner. In this way, linkage between the pulling button 52, the pulling rod 51, and the water diversion disk 3 is implemented. Therefore, the structure is simple, and convenience is brought to mounting. Specifically, the pulling rod 51 is a pulling piece 51 of a long-strip flaky structure, and is elastic. The pulling piece 51 implements a clamping connection to the connection seat 33 through elastic deformation. A connection manner is simple and reliable. Further, a guide portion 331 and a clamping block 332 are arranged on the connection seat 33. A clamping groove 511 is provided at an end of the pulling piece 51 away from the pulling button 52. The pulling piece 51 is inserted into the base 1 along the guide portion 331, to clamp the clamping block 332 into the clamping groove 511. The guide portion 331 enables the clamping block 332 to be smoothly aligned and clamped with the clamping groove 511. A clamping structure is simple.

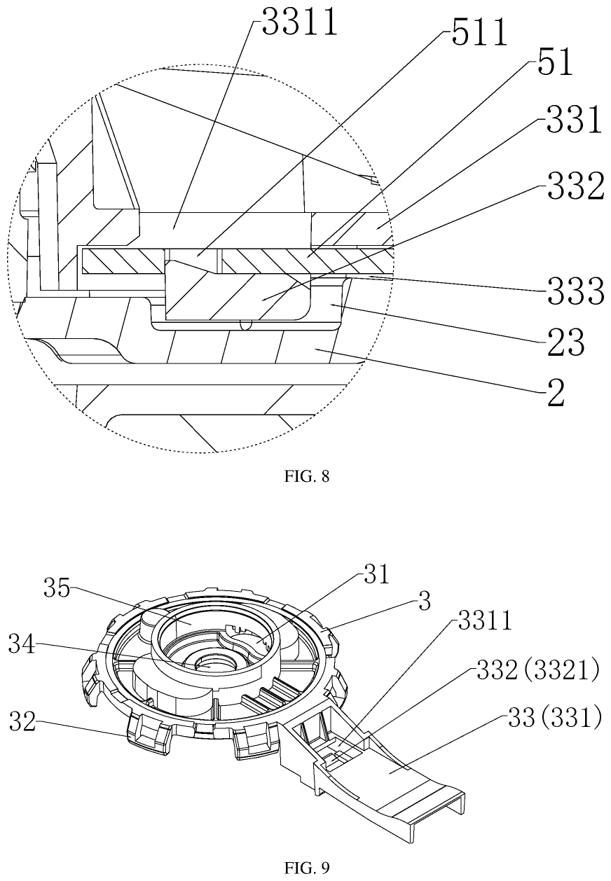

More specifically, the guide portion 331 of the connection seat 33 extends in a radial direction of the water diversion disk 3. A slot 333 is formed between the guide portion 331 and a top surface of the water diversion plate 2. The clamping block 332 is located in the slot 333. An avoiding groove 3311 communicated with the slot 333 is provided at a position of the guide portion 331 corresponding to the clamping block 332. The avoiding groove 3311 avoids elastic deformation of the pulling piece 51 to enable the pulling piece 51 to go over the clamping block 332. The pulling piece 51 is inserted into the slot 333, and is clamped with the clamping block 332 after elastically deformed at the avoiding groove 3311. With such design, a clamping structure is simple and reliable. Further, preferably, refer to FIG. 8 and FIG. 9. A guide bevel 3321 gradually inclined upward in an insertion direction of the slot 333 is arranged on a top surface of the clamping block 332. An end portion of the pulling piece 51 may be elastically deformed upward along the guide bevel 3321, so as to go over the clamping block 332 and move to a position of the clamping groove 511 corresponding to the clamping block 332. In this case, the pulling piece 51 is restored downward through elastic deformation of the pulling piece 51, so that the clamping block 332 is clamped into the clamping groove 511, to implement the clamping connection between the pulling piece 51 and the connection seat 33.

To insert the pulling piece 51 into the base 1 more reliably and conveniently, in this embodiment, an end of the guide portion 331 away from the water diversion disk 3 is upturned to a top direction of the base 1 to gradually enlarge a size of the slot 333 corresponding to an upturned part externally to a radial direction of the water diversion disk 3. In this way, the pulling piece 51 can be inserted into the slot 333 along the upturned part of the guide portion 331. A sinking groove 23 is formed at a position that is on the top surface of the water diversion plate 2 and that corresponds to the clamping block 332. The clamping block 332 is partially located in the sinking groove 23.

In this embodiment, the top shower further includes a flow passage seat 6 arranged in the base 1 and fixedly connected to the water diversion disk 3. The water inlet connector 4 includes a spherical portion 41. The spherical portion 41 is rotatably arranged in the flow passage seat 6, and is in sealing communication with the water diversion port 31 of the water diversion disk 3 through the flow passage seat 6.

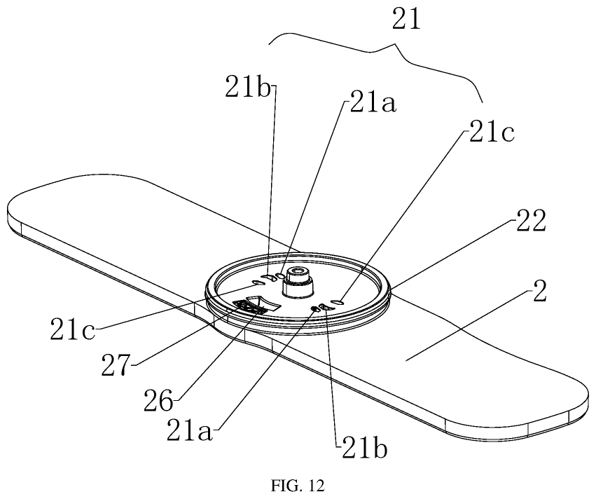

Specifically, a protruding rotating shaft 24 (refer to FIG. 12) is arranged on the top surface of the water diversion plate 2. The water diversion disk 3 is provided with a first central hole 34. The flow passage seat 6 is provided with a second central hole 61. The rotating shaft 24 is arranged in the first central hole 34 and the second central hole 61 in a penetration manner. A screw hole that axially extends is provided in the rotating shaft 24. A screw 7 is capable of penetrating through the water inlet connector 4 to be matched with the screw hole to fixedly connect the flow passage seat 6, the water diversion disk 3, and the water diversion plate 2. The screw 7 penetrates through the water inlet connector 4 to be matched with the screw hole to fixedly connect the flow passage seat 6, the water diversion disk 3, and the water diversion plate 2. Therefore, the structure is simple, and convenience is brought to assembling.

In this embodiment, refer to FIG. 12. There are two groups of flow diversion ports 21 that are opposite to each other. Each group of flow diversion ports 21 include a first flow diversion port 21a, a second flow diversion port 21b, and a third flow diversion port 21c that are arranged side by side. There are correspondingly two water diversion ports. The water outlets 111 include first water outlets 111a, second water outlets 111b, and third water outlets 111c. The water outlet channels 13 include a first water outlet channel 13a, a second water outlet channel 13b, and a third water outlet channel 13c. A first flow passage water channel 25a communicating the first flow diversion port 21a with the first water outlet 111a, a second flow passage water channel 25b communicating the second flow diversion port 21b with the second water outlet 111b, and a third flow passage water channel 25c communicating the third flow diversion port 21c with the third water outlet 111c are provided in the water diversion plate 2. The first flow diversion port 21a is communicated with the first water outlet 111a through the first flow passage water channel 25a and the first water outlet channel 13a. The second flow diversion port 21b is communicated with the second water outlet 111b through the second flow passage water channel 25b and the second water outlet channel 13b. The third flow diversion port 21c is communicated with the third water outlet 111c through the third flow passage water channel 25c and the third water outlet channel 13c. There is one first flow passage water channel 25a communicated with the two first diversion ports 21a. There are two second flow passage water channels 25b and two third flow passage water channels 25c that are communicated with the two second flow diversion ports 21b and the two third flow diversion ports 21c in one-to-one correspondence respectively. The two second flow passage water channels 25b and the two third flow passage water channels 25c enclose a quadrangle. The two second flow passage water channels 25B are arranged diagonally. The two third flow passage water channels 25c are arranged diagonally. The first flow passage water channel 25a is annular, and is arranged in middle in the quadrangle. Such design can make the water channels arranged more compact. When the water diversion plate 2 is sealed through welding, welding lines may be formed between the flow passage water channels, so that higher welding strength and higher resistance to water pressure are ensured.

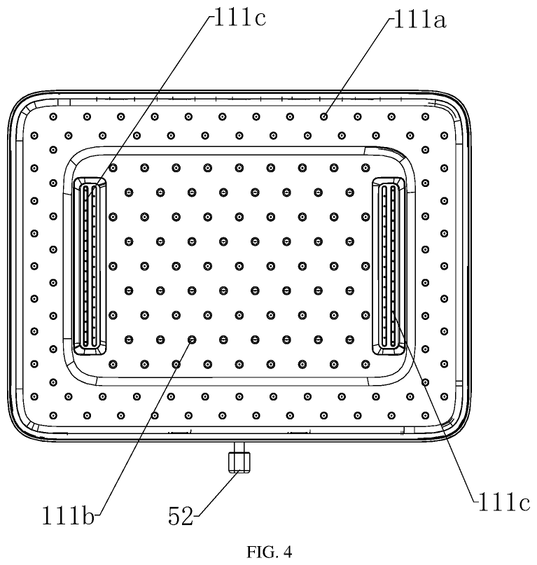

Specifically, in this embodiment, refer to FIG. 4. The first water outlet 111a, the second water outlet 111b, and the third water outlet 111c implement outer-circle water discharge, middle water discharge, and water discharge on both sides respectively.

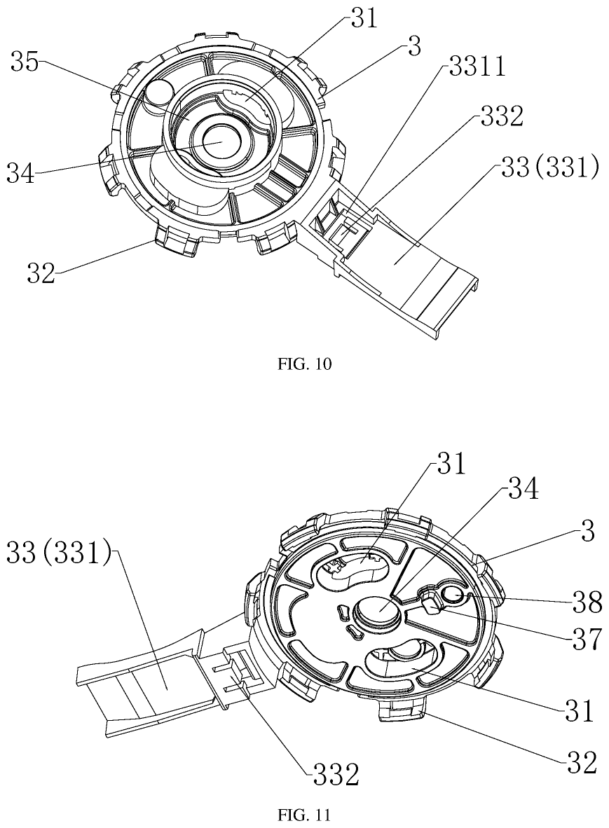

Refer to FIG. 9 and FIG. 10. In this embodiment, a water diversion cavity 35 is provided in the water diversion disk 3. A top wall of the water diversion cavity 35 forms an opening. A side wall of the water diversion cavity 35 is communicated with that of the water diversion port 31. Projections of the opening and the water diversion port 31 in an axial direction of the water diversion disk 3 partially overlap. Such design can make it easier to implement injection molding, the water diversion cavity 35 and the water diversion port 31 can be communicated with each other after molded through two die cores respectively, and no additional side core-pulling for forming a side communication port to communicate the water diversion cavity 35 with the water diversion port 31 is required. A sealing gasket 36 is arranged in the water diversion port 31. The sealing gasket 36 is provided with a water hole. Through the sealing gasket 36, the water diversion port 31 can form sealing communication with each flow diversion port 21 without water channeling between the flow diversion ports 21.

Refer to FIG. 12. a limiting groove 26 and three gear grooves 27 are further provided on the top surface of the water diversion plate 2. Refer to FIG. 11. A limiting block 37 and an elastic pin mounting seat 38 are arranged on the water diversion disk 3. The limiting block 37 is located in the limiting groove 26. Two ends of the limiting groove 26 are pressed against the limiting block 37, to limit a rotation range of the water diversion disk 3. An elastic pin (not shown in the figure) is mounted in the elastic pin mounting seat 38. The elastic pin is matched with the gear groove 27. When the water diversion disk 3 rotates, the elastic pin is sequentially embedded into the gear groove 27, to locate the water diversion disk 3 and indicate a rotation gear.

It should be noted that in the disclosure, the quantity of water outlets 111, the quantity of water diversion ports 21, the quantity of flow passage water channels, and the quantity of water outlet channels 13 can be designed as required, and are not limited to those mentioned herein.

The above is merely the preferred embodiment of the disclosure and not thus intended to limit the scope of protection of the disclosure. Therefore, any equivalent variations made according to the structure, the shape, and the principle in the disclosure shall fall within the scope of protection of the disclosure.

What is claimed is:

1. A top shower, comprising a base, a water diversion plate, a water diversion disk, a water inlet connector, and an adjustment component, wherein
the water inlet connector is connected to a top surface of the base, and a variety of types of water outlets are provided on a bottom surface of the base;
the water diversion plate is fixedly arranged in the base, and is provided with a plurality of flow diversion ports at intervals in a circumferential direction of the water diversion disk, and the flow diversion ports are communicated with the water outlets respectively; the water diversion disk is rotatably arranged in the base, and is matched with the water diversion plate; and
a water diversion port is provided on the water diversion disk, and when the water diversion disk is rotated, the water diversion port is selectively communicated with the plurality of flow diversion ports; and the adjustment component comprises a pulling button movably arranged on a side of the base and a pulling rod connected to the water diversion disk and the pulling button respectively, and the pulling button drives, through the pulling rod, the water diversion disk to rotate.

2. The top shower according to claim 1, wherein the base comprises a water outlet panel, the water outlet is provided on the water outlet panel, water outlet channels correspondingly communicating the water diversion ports with the water outlets are formed between a bottom surface of the water diversion plate and a top surface of the water outlet panel, the water diversion port is provided on a top surface of the water diversion plate, a clamping ring groove is provided around the water diversion port on the top surface of the water diversion plate, the water diversion disk is provided with a plurality of elastic buckles at intervals in the circumferential direction of the water diversion disk, the plurality of elastic buckles are clamped into the clamping ring groove in an axial direction of the water diversion disk after elastically deformed, and the elastic buckle is movable in a circumferential direction of the clamping ring groove.

3. The top shower according to claim 1, wherein a connection seat is arranged on a periphery of the water diversion disk, and an end of the pulling rod away from the pulling button extends into the base, and is connected to the connection seat in a clamping manner.

4. The top shower according to claim 3, wherein the pulling rod is a pulling piece of a long-strip flaky structure, and is elastic, and the pulling piece implements a clamping connection to the connection seat through elastic deformation.

5. The top shower according to claim 4, wherein a guide portion and a clamping block are arranged on the connection seat, a clamping groove is provided at an end of the pulling piece away from the pulling button, and the pulling piece is inserted into the base along the guide portion, to clamp the clamping block into the clamping groove.

6. The top shower according to claim 5, wherein the guide portion of the connection seat extends in a radial direction of the water diversion disk, a slot is formed between the guide portion and a top surface of the water diversion plate, the clamping block is located in the slot, an avoiding groove communicated with the slot is provided at a position of the guide portion corresponding to the clamping block, the avoiding groove avoids elastic deformation of the pulling piece to enable the pulling piece to go over the clamping block, and the pulling piece is inserted into the slot, and is clamped with the clamping block after elastically deformed at the avoiding groove.

7. The top shower according to claim 6, wherein an end of the guide portion away from the water diversion disk is upturned to a top direction of the base to gradually enlarge a size of the slot corresponding to an upturned part externally to the radial direction of the water diversion disk, a sinking groove is formed at a position that is on the top surface of the water diversion plate and that corresponds to the clamping block, and the clamping block is partially located in the sinking groove.

8. The top shower according to claim 1, further comprising a flow passage seat arranged in the base and fixedly connected to the water diversion disk, wherein the water inlet connector comprises a spherical portion, and the spherical portion is rotatably arranged in the flow passage eat, and is in sealing communication with the water diversion port of the water diversion disk through the flow passage seat;
the base comprises a water outlet panel, the water outlet is provided on the water outlet panel, water outlet channels correspondingly communicating the flow diversion ports with the water outlets are formed between a bottom surface of the water diversion plate and a top surface of the water outlet panel, the water diversion port is provided on a top surface of the water diversion plate, a protruding rotating shaft is arranged on the top surface of the water diversion plate; and
the water diversion disk is provided with a first central hole, the flow passage seat is provided with a second central hole, the rotating shaft is arranged in the first central hole and the second central hole in a penetration manner, a screw hole that axially extends is provided in the rotating shaft, and a screw is capable of penetrating through the water inlet connector to be matched with the screw hole to fixedly connect the flow passage seat, the water diversion disk, and the water diversion plate.

9. The top shower according to claim 1, wherein there are two groups of flow diversion ports that are opposite to each other, each group of flow diversion ports comprise a first flow diversion port, a second flow diversion port, and a third flow diversion port that are arranged side by side, there are correspondingly two water diversion ports, the water outlets comprise a first water outlet, a second water outlet, and a third water outlet; and
a first flow passage water channel communicating the first flow diversion port with the first water outlet, a second flow passage water channel communicating the second flow diversion port with the second water outlet, and a third flow passage water channel communicating the third flow diversion port with the third water outlet are provided in the water diversion plate, there is one first flow passage water channel communicated with the two first diversion ports, there are two second flow passage water channels and two third flow passage water channels that are communicated with the two second flow diversion ports and the two third flow diversion ports in one-to-one correspondence respectively, the two second flow passage water channels and the two third flow passage water channels enclose a quadrangle, the two second flow passage water channels are arranged diagonally, the two third flow passage water channels are arranged diagonally, and the first flow passage water channel is annular, and is arranged in middle in the quadrangle.

10. The top shower according to claim 1, wherein a water diversion cavity is provided in the water diversion disk, a top wall of the water diversion cavity forms an opening, a side wall of the water diversion cavity is communicated with that of the water diversion port, projections of the opening and the water diversion port in an axial direction of the water diversion disk partially overlap, a sealing gasket is arranged in the water diversion port, and the sealing gasket is provided with a water hole.
